(19) United States
(12) Patent Application Publication
(10) Pub. No.: US 2013/0144693 A1
(43) Pub. Date: Jun. 6, 2013

(54) Electronic Solicitation of User Incentives and Account Statistics From a Plurality of Electronic Payment Processors

(71) Applicant: ARAM NAHIDIPOUR, Laguna Niguel, CA (US)

(72) Inventor: ARAM NAHIDIPOUR, Laguna Niguel, CA (US)

(73) Assignee: BROADCOM CORPORATION, IRVINE, CA (US)

(21) Appl. No.: 13/311,394

(22) Filed: Dec. 5, 2011

(51) Int. Cl. G06Q 30/02; G06Q 40/00

(52) U.S. Cl. 705/14.4; 705/35; 705/39; 705/26.1

(57) ABSTRACT

Electronically soliciting user incentives and account statistics from a plurality of electronic payment processors is described. An exemplary method may include retreiving, using a processor of a device, a plurality of user account information assigned to a user for each of the plurality of electronic payment processors, respectively. The method may further include transmitting, using the processor of the device, the plurality of user account information for each of the plurality of electronic payment processors, respectively. The method may further include receiving, using the processor of the device, one or more incentive quotes from at least one of the plurality of electronic payment processors in response to the transmitting of the plurality of user account information. The one or more incentive quotes may be displayed to the user on a display of the device.

### BACKGROUND

Conventionally, the use of electronic payment processors, such as credit cards, bank and credit union backed checking and savings accounts, and the like has been non-interactive and fairly uninformed. For example, the average person has approximately nine credit cards, the majority of which offer incentives in an effort to convince account holders to utilize a particular electronic payment processor or to open an account to gain their patronage. Such incentives may include cash back, bonus points or frequent flier miles, or temporary attractive interest rates. However, an account holder is generally notified of the terms under which these incentives are awarded only when the account is opened or when a material change has been made to those terms thereafter. The consumer may be informed of such terms or material changes by commercial advertisement on TV, newspaper advertisements, monthly statements, and the like.

In addition, to determine the status of accumulated incentives, an account holder is required to login separately to each account online or call customer service separately for each account. As a result, the average account holder is largely unaware of the status of these accumulated incentives or the status of account statistics in general due to the inconvenience involved in obtaining incentive or account statistics updates. Thus, the average consumer often makes decisions based only on what he or she believes to be accurate information regarding the account statistics for each of his or her accounts. Because the average consumer has as many as nine credit cards to choose from for funding purchases and transactions, an informed decision as to which payment method to use can be very difficult to make while performing a transaction.

### SUMMARY

The present application provides for electronically soliciting user incentives and account statistics from a plurality of electronic payment processors, substantially as shown in and/or described in connection with at least one of the figures, as set forth more completely in the claims.

### BRIEF DESCRIPTION OF THE DRAWINGS

FIG. 1A presents an exemplary diagram of a system for electronically soliciting user incentives and account statistics from a plurality of electronic payment processors, in accordance with one implementation;

FIG. 1B presents an exemplary diagram of another system for electronically soliciting user incentives and account statistics from a plurality of electronic payment processors, in accordance with one implementation;

FIG. 1C presents an exemplary diagram of yet another system for electronically soliciting user incentives and account statistics from a plurality of electronic payment processors, in accordance with one implementation;

FIG. 1D presents an exemplary diagram of yet another system for electronically soliciting user incentives and account statistics from a plurality of electronic payment processors, in accordance with one implementation;

FIG. 1E presents an exemplary diagram of yet another system for electronically soliciting user incentives and account statistics from a plurality of electronic payment processors, in accordance with one implementation;

FIG. 1F presents an exemplary diagram of yet another system for electronically soliciting user incentives and account statistics from a plurality of electronic payment processors, in accordance with one implementation;

FIG. 1G presents an exemplary diagram of yet another system for electronically soliciting user incentives and account statistics from a plurality of electronic payment processors, in accordance with one implementation;

FIG. 1H presents an exemplary diagram of yet another system for electronically soliciting user incentives and account statistics from a plurality of electronic payment processors, in accordance with one implementation;

FIG. 2A presents one or more exemplary devices that may be utilized in a system for electronically soliciting user incentives and account statistics from a plurality of electronic payment processors, in accordance with one implementation;

FIG. 2B presents an exemplary display showing account statistics from a plurality of electronic payment processors, in accordance with one implementation;

FIG. 2C presents an exemplary display showing incentive quotes from a plurality of electronic payment processors, in accordance with one implementation;

FIG. 3 presents an exemplary flowchart describing a method for electronically soliciting user incentives and account statistics from a plurality of electronic payment processors, in accordance with one implementation;

FIG. 4 presents an exemplary flowchart describing another method for electronically soliciting user incentives and account statistics from a plurality of electronic payment processors, in accordance with one implementation; and

FIG. 5 presents an exemplary flowchart describing yet another method for electronically soliciting user incentives and account statistics from a plurality of electronic payment processors, in accordance with one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The following description provides many benefits and advantages of one or more implementations of exemplary systems, devices and methods for electronically soliciting user incentives and account statistics from a plurality of electronic payment processors. In one exemplary implementation a user may simultaneously obtain account statistics regarding each of his or her credit accounts for comparison purposes. For example, in one such implementation, the user is able to obtain account statistics such as total credit, current balance, remaining credit, one or more interest rates, etc., for two or more customer accounts at the same time. Once the user has compared the account statistics, the user may optionally select a desired credit account for a particular potential transaction.

In another exemplary implementation, a user will be able to auction a real-time transaction or auction a contemplated potential transaction to two or more of his or her credit providers to determine which will offer the most desirable incentive in exchange for using that credit provider to complete the desired transaction.

In yet another exemplary implementation, retailers will also be able to offer their own incentives in exchange for a customer deciding to open a credit account with that particular retailer, or to use an already existing credit account with that particular retailer to complete the transaction.

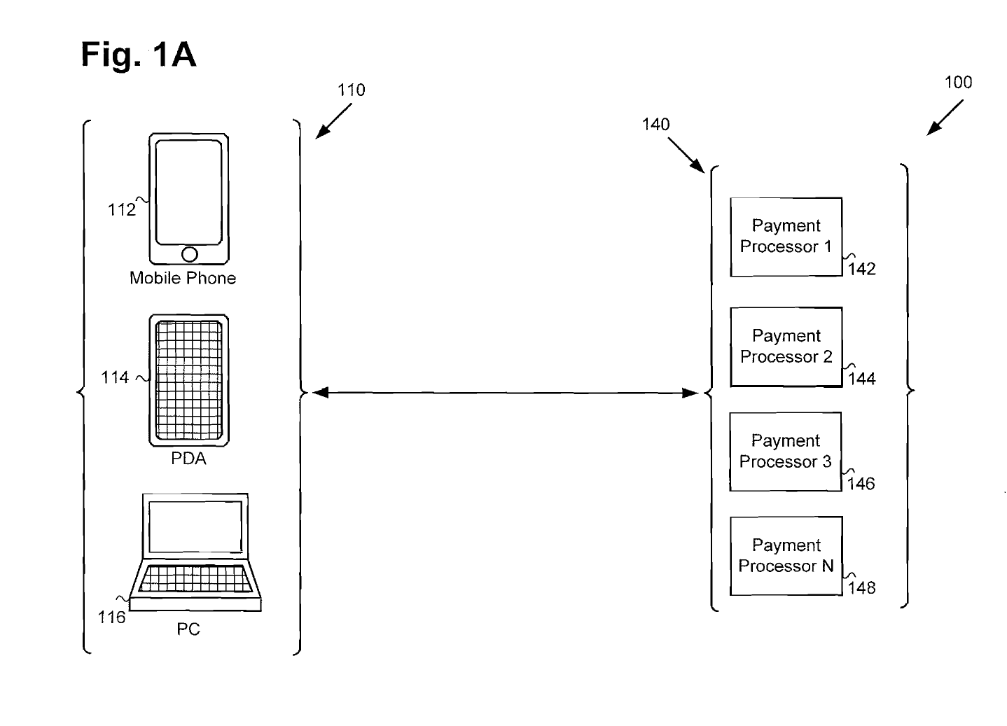

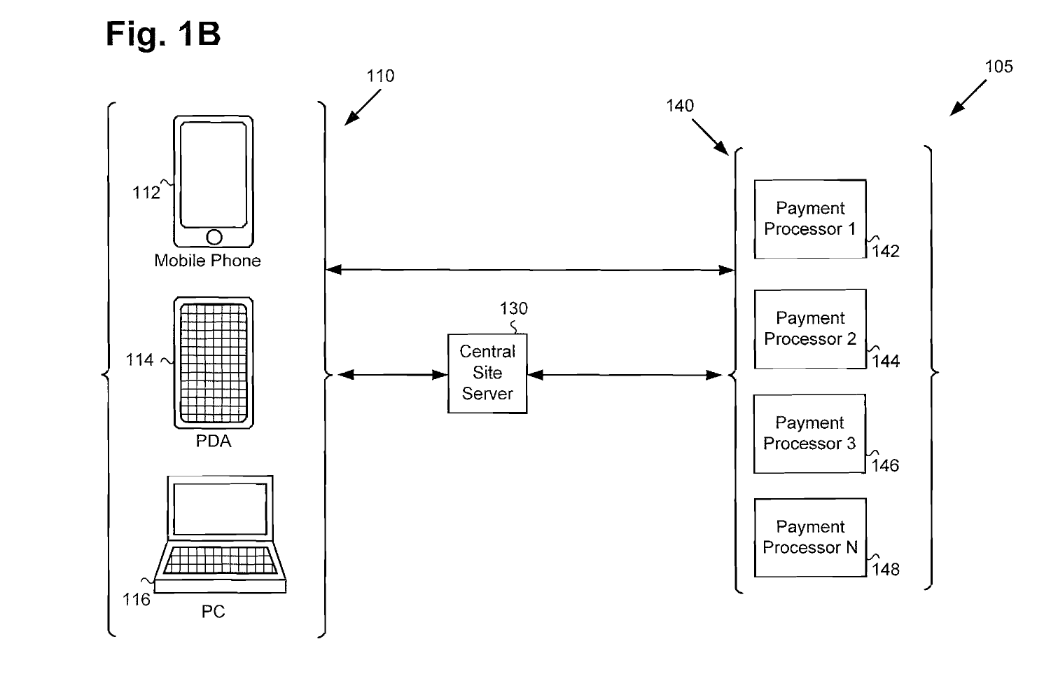

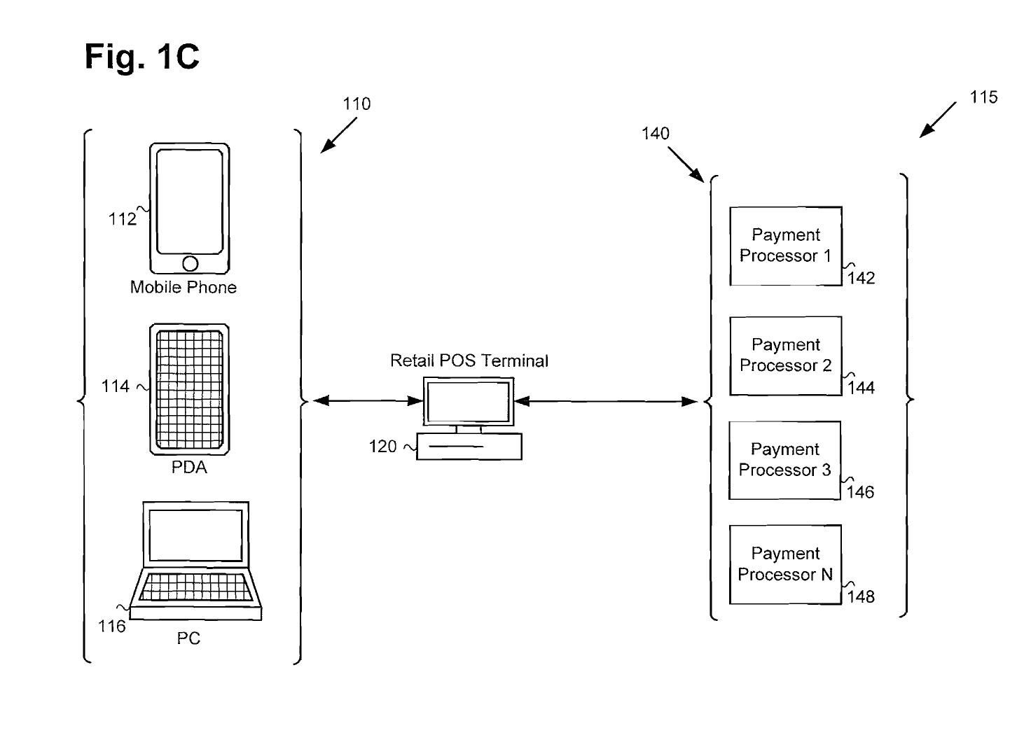

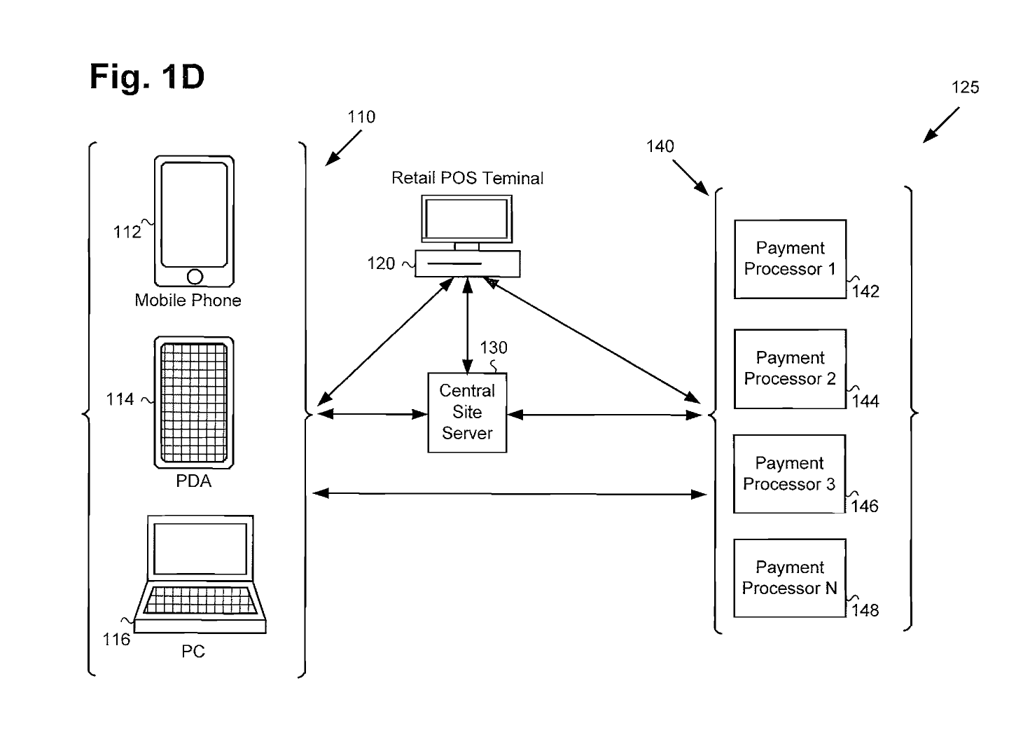

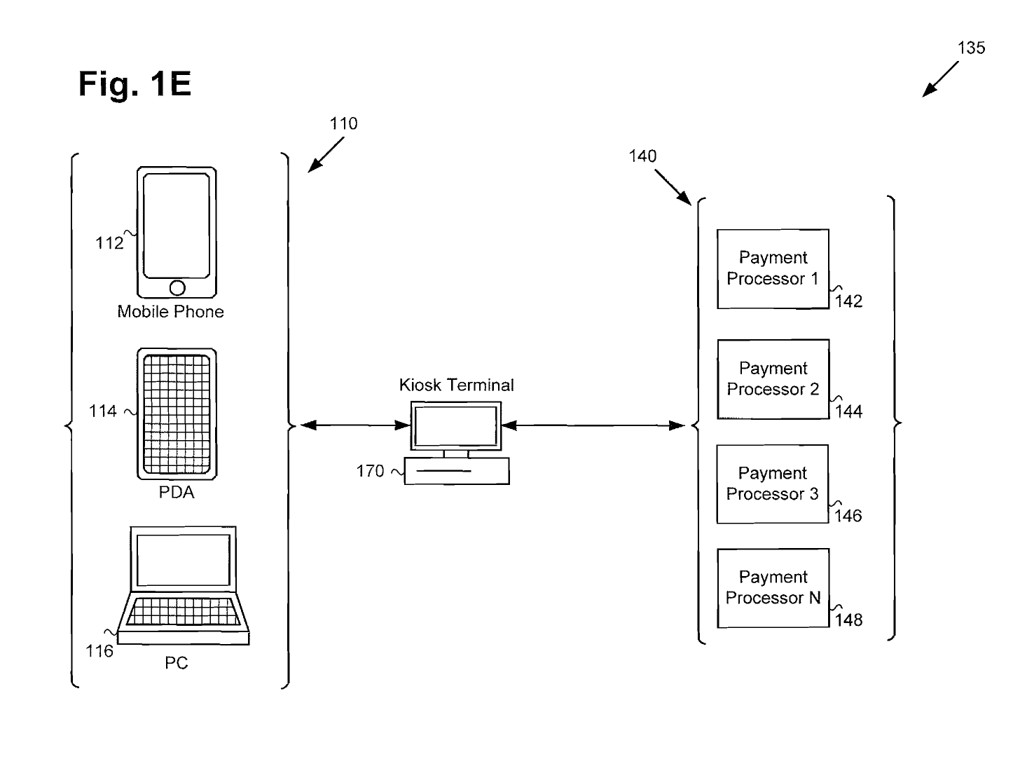

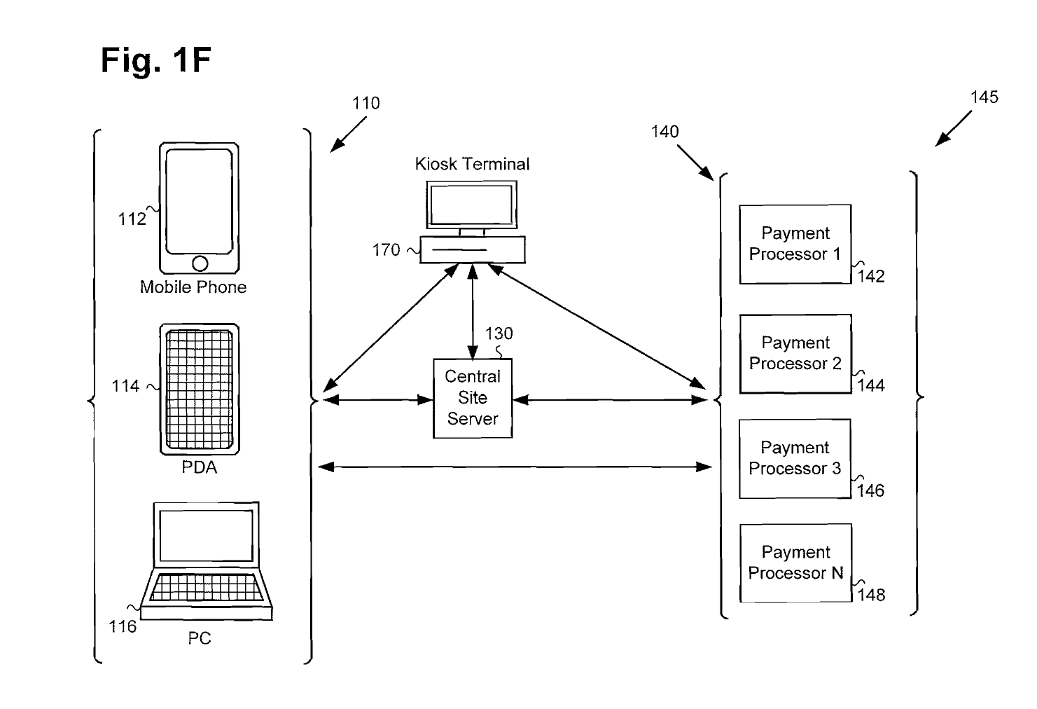

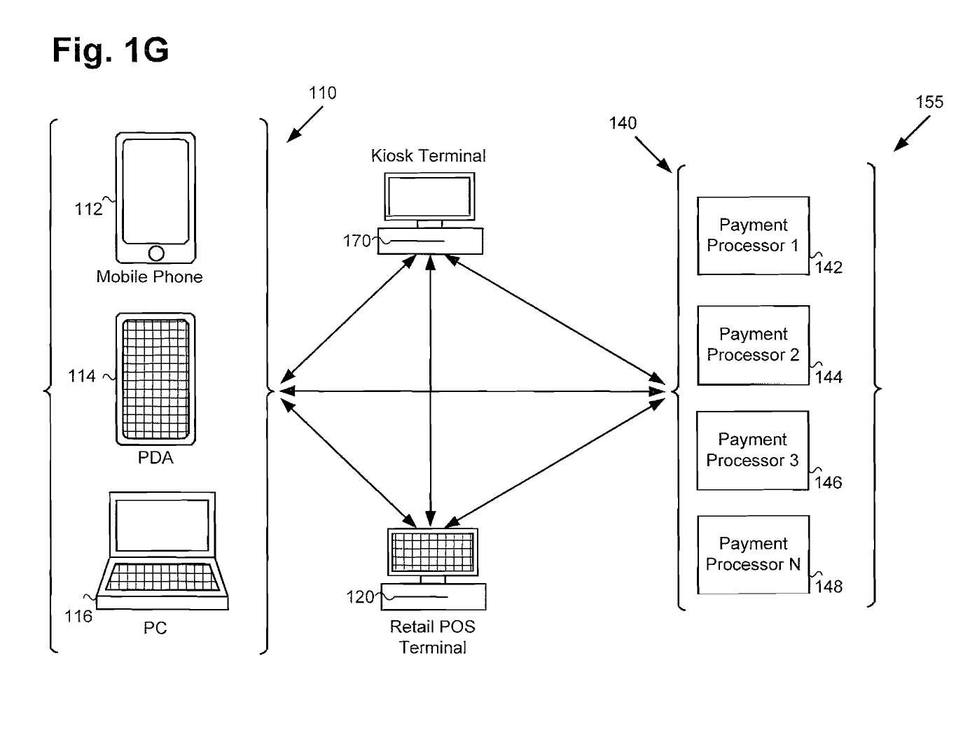

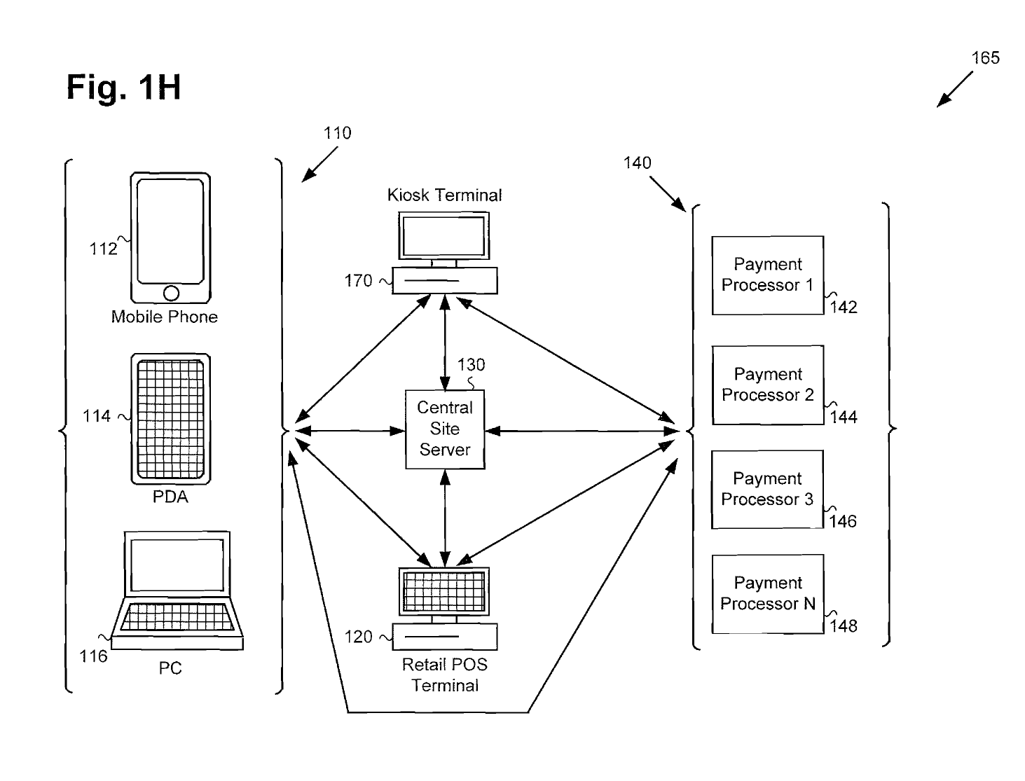

Turning to the figures, FIG. 1A shows exemplary system 100 including one or more devices for electronically soliciting user incentives and account statistics from a plurality of electronic payment processors. According to the implementation of FIG. 1A, system 100 may include one or more first devices 110, which may be a mobile phone 112, a personal digital assistant (PDA) 114, a personal computer (PC) 116, or any other suitable device capable of secured or unsecured wireless or wired communication via a network, such as the Internet for example. System 100 also includes a plurality of electronic payment processors 140, which may include individual payment processors (1 . . . N) 142, 144, 146 and 148, for example. The plurality of electronic payment processors 140 may include processors such as American Express, Visa, MasterCard, Discover Card, Bankcard, China UnionPay, Diners Club, InstaPayment, JCB, Laser, Maestro, Solo, Switch, or and any other credit or debit based card or account which may further include retail store credit card entities, banks or credit unions, debit cards, etc.

Each of the one or more first devices 110, may communicate with the plurality of electronic payment processors 140 according to one or more implementations disclosed herein. System 100 may further utilize near field communication protocols, 2G, 3G, 4G, WiFi, Zigbee, Bluetooth, Ethernet, USB, SDIO or any other wireless or wired communication protocol in receiving or transmitting information as necessary between one or more devices within the system.

Each of the one or more first devices 110, may also be capable of displaying account statistics associated with a particular user regarding one or more of the plurality of electronic payment processors 140. Examples of such account statistics may include an account balance, a total credit line amount, a remaining credit amount, an amount of accrued incentives, one or more interest rates, or any other information that may be associated with a user's account from an electronic payment processor. Each of the one or more first devices 110 may be further capable of displaying one or more incentive quotes, generic for particular electronic payment processors or specific to a particular user, either offered in real-time regarding a real-time transaction or regarding a tentative transaction at some point in the future. Thus, system 100 allows a user to electronically solicit incentive quotes and account statistics from a plurality of electronic payment processors, according to one or more implementations disclosed herein.

FIG. 1B shows exemplary system 105, which may be configured substantially as system 100 of FIG. 1A, however, further including a central site server 130, which may be a centrally located database or server, for example, for communicating with each of the one or more first devices 110 as well as each of the plurality of electronic payment processors 140. In such an implementation, central site server 130 may act essentially as an intermediary amongst each of the one or more first devices 110 and the plurality of electronic payment processors 140. Thus, each of the one or more first devices 110 are not necessarily required to directly contact and communicate with each and every one of the plurality of electronic payment processors 140.

FIG. 1C shows exemplary system 115, which may be configured substantially as system 100 of FIG. 1A, however, further including a second device, such as a point of sale (POS) terminal 120, for example. POS terminal 120 may communicate with each of the one or more first devices 110 as well as the plurality of electronic payment processors 140 according to one or more implementations disclosed herein.

POS terminal 120 may also be capable of displaying account statistics associated with a particular user regarding one or more of the plurality of electronic payment processors 140. POS terminal 120 may be further capable of displaying one or more incentive quotes specific to a particular user either offered in real-time regarding a real-time transaction or regarding a tentative transaction at some point in the future. Thus, system 115 allows a user to electronically solicit incentive quotes and/or account statistics from a plurality of electronic payment processors, according to one or more implementations disclosed herein.

FIG. 1D shows exemplary system 125, which may be configured substantially as system 115 of FIG. 1C, however, further including central site server 130 for communicating with each of the one or more first devices 110, POS terminal 120, and each of the plurality of electronic payment processors 140. In such an implementation, central site server 130 may act essentially as an intermediary amongst each of the one or more first devices 110, POS terminal 120, and the plurality of electronic payment processors 140. Thus, each of the one or more first devices 110 and POS terminal 120 are not necessarily required to directly contact and communicate with each and every one of the plurality of electronic payment processors 140.

FIG. 1E shows exemplary system 135, which may be configured substantially as system 100 of FIG. 1A, however, further including a kiosk terminal 170, for example. Kiosk terminal 170 may be a stand-alone terminal placed at any required location, such as in a mall or department store, or as a supplement to existing retail POS devices not capable of directly interacting with a system according to one or more implementations disclosed herein. Kiosk terminal 170 communicates with each of the one or more first devices 110 as well as the plurality of electronic payment processors 140 according to one or more implementations disclosed herein.

Kiosk terminal 170 may also be capable of displaying account statistics associated with a particular user regarding one or more of the plurality of electronic payment processors 140. Kiosk terminal 170 may be further capable of displaying one or more incentive quotes specific to a particular user either offered in real-time regarding a real-time transaction or regarding a tentative transaction at some point in the future. Thus, system 135 allows a user to electronically solicit incentive quotes and account statistics from a plurality of electronic payment processors, according to one or more implementations disclosed herein.

FIG. 1F shows exemplary system 145, which may be configured substantially as system 135 of FIG. 1E, however, further including central site server 130 for communicating with each of the one or more first devices 110, kiosk terminal 170, and each of the plurality of electronic payment processors 140. In such an implementation, central site server 130 may act essentially as an intermediary amongst each of the one or more first devices 110, kiosk terminal 170, and the plurality of electronic payment processors 140. Thus, each of the one or more first devices 110 and kiosk terminal 170 are not necessarily required to directly contact and communicate with each and every one of the plurality of electronic payment processors 140.

FIG. 1G shows exemplary system 155, which may be configured substantially as system 135 of FIG. 1E, however, further including retail POS device 120, for example. POS terminal 120 may or may not directly interact with a system according to one or more implementations disclosed herein. Thus, kiosk terminal 170 may act as a supplementary device to a pre-existing retail POS terminal where that POS terminal is not capable of carrying out implementations or methods as disclosed herein. POS terminal 120 may communicate with each of the one or more first devices 110, kiosk terminal 170, as well as the plurality of electronic payment processors 140 according to one or more implementations disclosed herein.

FIG. 1H shows exemplary system 165, which may be configured substantially as system 155 of FIG. 1G, however, further including central site server 130 for communicating with each of the one or more first devices 110, POS terminal 120, kiosk terminal 170, and each of the plurality of electronic payment processors 140. In such an implementation, central site server 130 may act essentially as an intermediary amongst each of the one or more first devices 110, POS terminal 120, kiosk terminal 170, and the plurality of electronic payment processors 140. Thus, each of the one or more first devices 110, POS terminal 120, and kiosk terminal 170 are not necessarily required to directly contact and communicate with each and every one of the plurality of electronic payment processors 140.

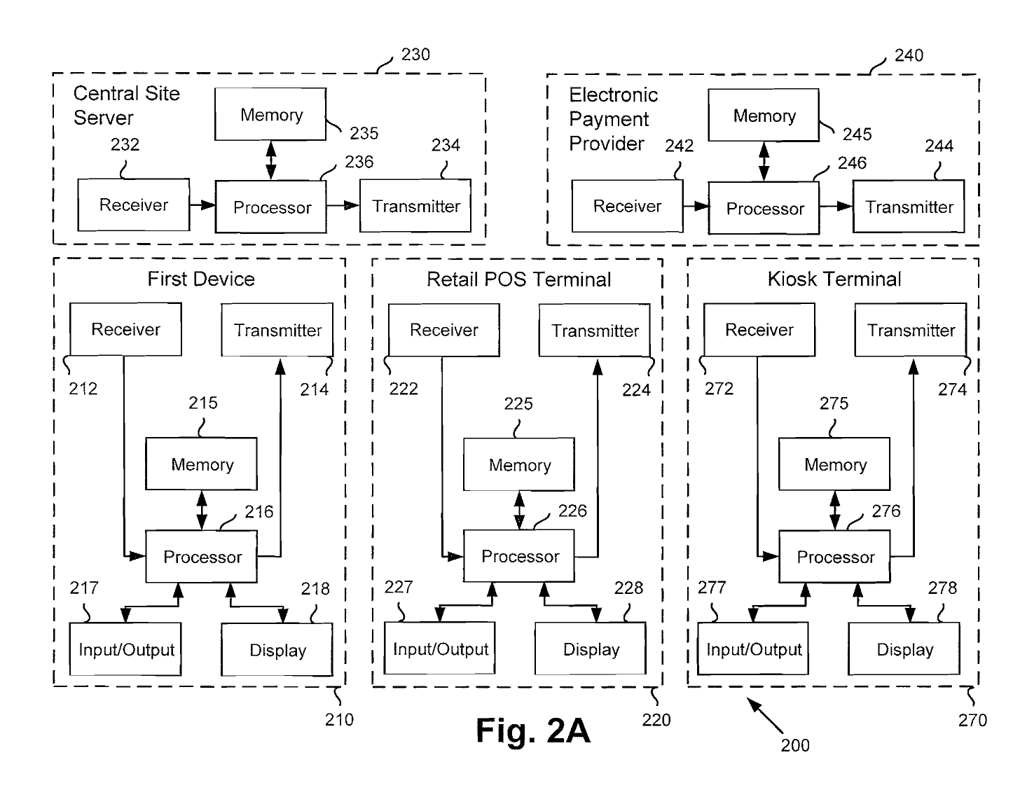

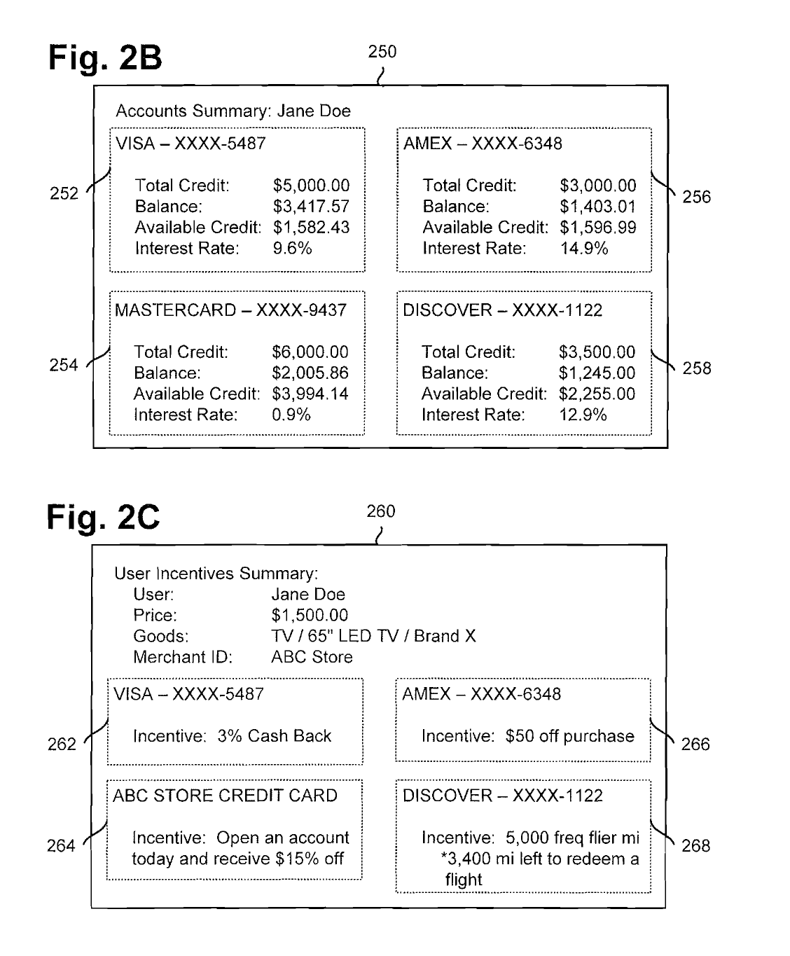

FIG. 2A shows one or more exemplary devices, which may be utilized in a system for electronically soliciting user incentives and account statistics from a plurality of electronic payment processors. Such systems may include any of the systems previously described in FIGS. 1A-1H, for example. According to the implementation of FIG. 2A, system 200 may include a first device 210, POS terminal 220, kiosk terminal 270, electronic payment processor 240, and/or central site server 230. Each of the devices shown in FIG. 2A may be assumed to correspond to their equivalent device as described in any of FIGS. 1A-1H.

First device 210 may include receiver 212, processor 216, transmitter 214, memory 215, input/output module 217, and display 218, and may electronically solicit user incentives and account statistics from a plurality of electronic payment processors, according to one or more methods disclosed herein. Within first device 210, receiver 212 may be in communication with processor 216 and may receive one or more parameters of a potential transaction, for instance, from POS terminal 220. First device 210 may also receive one or more incentive quotes from at least one of the plurality of electronic payment processors, for example. Transmitter 214 is also in communication with processor 216 and may transmit the one or more parameters of the potential transaction retrieved from memory 215, for example. First device 210 may be further equipped to communicate with other devices in close proximity, for example, POS terminal 220 or kiosk terminal 270, by near field communication (NFC) protocols, 2G, 3G, 4G, WiFi, Zigbee, Bluetooth, Ethernet, USB, SDIO or any other wireless or wired communication protocol. Memory 215 may further be in communication with processor 216 and may store the one or more parameters of the potential transaction, for example, and may also store a plurality of user account information for each of the plurality of electronic payment processors. Display 218 may be in communication with processor 216 and may display one or more incentive quotes from at least one of the plurality of electronic payment processors for user selection. However, display 218 may also display any other data to the user as required, including the status of current incentives offered or already accumulated with respect to one or more electronic payment processors with which the user is already associated. Finally, input/output module 217 may be in communication with processor 216 and may allow a user to input any required information, which may include his or her selection of one or more of the electronic payment processors according to one or more methods disclosed herein. Input/output module 217 may include a touch screen, a mouse, a keyboard, or any other input/output device.

Likewise, POS terminal 220 may include receiver 222, processor 226, transmitter 224, memory 225, input/output module 227 and display 228, arranged substantially as described above regarding first device 210. Receiver 222 may receive user account information regarding a user's account with one or more electronic payment processors. Receiver 222 may also receive one or more incentive quotes from at least one of the plurality of electronic payment processors, for example, to either be displayed to a user or to be transmitted to first device 210 for display to the user by first device 210. Transmitter 224 may transmit one or more parameters of a potential transaction to first device 210, for example. POS terminal 220 may be further equipped to communicate with other devices in close proximity, specifically first device 210 and/or kiosk device 270, by near field communication (NFC) protocols, 2G, 3G, 4G, WiFi, Zigbee, Bluetooth, Ethernet, USB, SDIO or any other wireless or wired communication protocol. Memory 225 may store the one or more parameters of the potential transaction as well as any other information related to a potential transaction. Display 228 may enable POS terminal 220 to display the one or more incentive quotes from the at least one of the plurality of electronic payment processors to the user but may also display account statistics associated with one or more of a plurality of electronic payment processors. Finally, input/output module 227 may be in communication with processor 226 and may allow a user to input any required information, which may include his or her selection of one or more of the electronic payment processors according to one or more methods disclosed herein. Input/output module 227 may include a touch screen, a mouse, a keyboard, or any other input/output device.

Kiosk terminal 270 may be a stand-alone terminal placed at any required location such as in a mall or in a department store, or as a supplement to an existing retail POS terminal, for example. Kiosk terminal 270 may be configured substantially as POS terminal 220, as described above, and may include receiver 272, processor 276, transmitter 274, memory 275, input/module 277 and display 278, similarly arranged.

Central site server 230 may include, for example, receiver 232, processor 236, transmitter 234, and memory 235 arranged substantially as described above regarding first device 210, POS terminal 220, and kiosk terminal 270. Central site server 230 may act essentially as an intermediary between first device 210, POS terminal 220, and/or kiosk terminal 270, and each of the plurality of electronic payment processors during the user incentive and account statistics soliciting process. Receiver 232 may receive any data, which may be a part of a communication between any of first device 210, POS terminal 220, kiosk terminal 270, and any of the plurality of electronic payment processors. Transmitter 234 may transmit any data received or internally generated to an intended end device, for instance, first device 210, POS terminal 220, kiosk terminal 270, and/or any of the plurality of electronic payment processors. Furthermore, memory 235 may store any received, transmitted or internally generated data, as required, according to one or more implementations disclosed herein.

Finally, electronic payment processor 240 may include, for example, receiver 242, processor 246, transmitter 244, and memory 245 arranged substantially as described above regarding central site server 230. Electronic payment processor 240 may be a server, for example, and may be configured to generate one or more incentive quotes or account statistics for a user in response to a request from any of first device 210, retail POS terminal 220, kiosk terminal 270, or central site server 230, according to one or more implementations disclosed herein.

Moving to FIGS. 2B and 2C, FIG. 2B shows an exemplary display 250 which may correspond to the displays of any device disclosed in any of FIGS. 1A-1H and 2A. Display 250 is shown to display exemplary account statistics associated with a users account with one or more of a plurality of electronic payment processors. In one specific example, a user Jane Doe, has 4 credit card accounts. Exemplary sets of account statistics 252, 254, 256 and 258 are displayed for each of her credit card accounts. In this example, the account statistics include total credit, balance, available credit, and the interest rate of each of the cards. Thus, display 250 enables Jane Doe to view critical account statistics pertaining to each of her credit card accounts for her instant reference, or in anticipation of an upcoming purchase or transaction.

FIG. 2C shows another exemplary display 260 which may correspond to the displays of any of the displays of any device disclosed in any of FIGS. 1A-1H and 2A. Display 260 is shown to display one or more incentive quotes from a plurality of electronic payment processors with which Jane Doe may be associated. Exemplary sets of incentive quotes 262, 264, 266 and 268 are displayed for each of her credit accounts. Additionally, incentive quote set 264 includes incentive quotes provided by a retail store ‘ABC Store’, for example. Incentive quote set 264 may be provided by ABC store, for example, in an effort to convince Jane Doe to open a credit card account provided by ABC Store or one of its business partners. In exchange, ABC Store offers Jane Doe a 15% discount on the identified purchase if she opens such an account and uses it to complete the transaction, for example. In such an example, ABC Store or its business partner offering the credit line may become one of the plurality of electronic payment processors with which Jane Doe is associated. Thus, display 260 enables Jane Doe to view one or more incentive quotes from each of her credit card accounts for her instant reference and in anticipation of an upcoming purchase or transaction. Additionally, one or more implementations of the present inventive concepts may generate and display both account statistics, as in FIG. 2B, and incentive quotes, as in FIG. 2C.

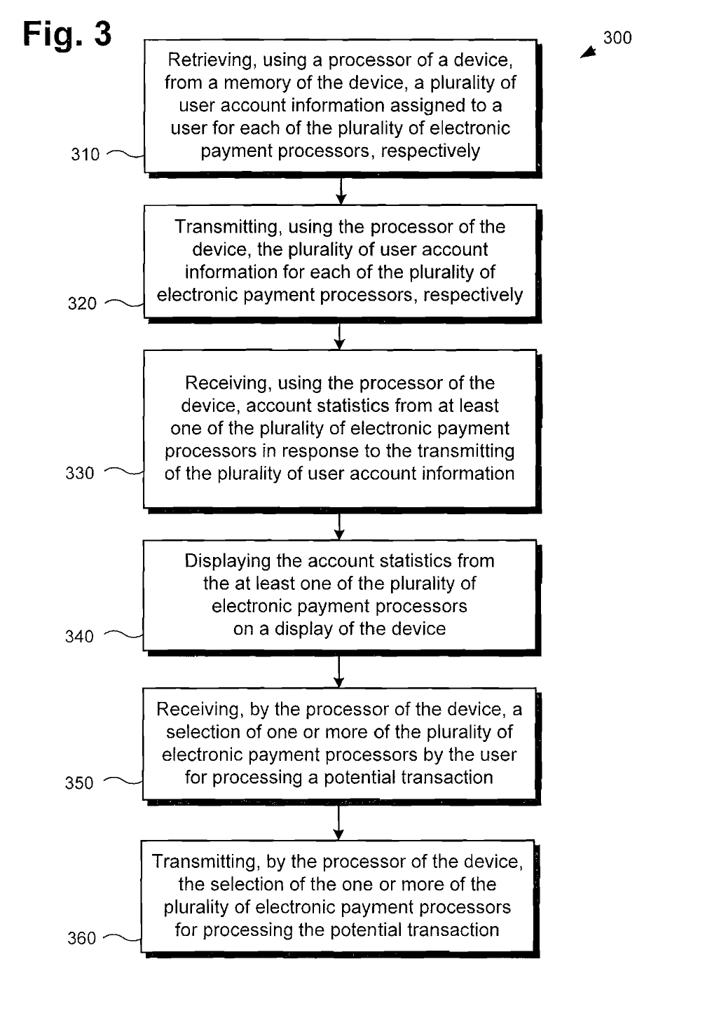

The operation of the systems disclosed in FIGS. 1A-1H will now be further described by reference to FIGS. 2A-2C and 3. FIG. 3 shows a flowchart describing a first exemplary implementation of a method for electronically soliciting user incentives and account statistics from a plurality of electronic payment processors. By this first implementation, a user primarily interfaces directly with a first device 210, such as the user's smartphone, PDA, PC, or any other or any other suitable device capable of being secured or unsecured wireless or wired communication via a network, for example.

Action 310 of flowchart 300 includes retrieving, using a processor of a device, from a memory of the device, a plurality of user account information assigned to the user for each of the plurality of electronic payment processors, respectively. Referring, for example, to FIG. 2A, action 310 may be performed by first device 210, utilizing processor 216, memory 215, input/output module 217 and display 218. Such user account information may include the user's name, address, account numbers, or any other information which may be used to identify a user and a particular associated account from an electronic payment processor. In one implementation, a user may enter the account information associated with each of a plurality of electronic payment processors with which he or she is associated. For example, a user may manually enter his or her account information associated with each of his or her credit cards into first device 210 using input/output module 217, for example, which may save the account information for easy retrieval as needed. This information may alternatively be automatically collected by first device 210 utilizing near field communication (NFC), for example, when a smart card containing the user's account information is brough into close proximity with first device 210. This information may further alternatively be automatically collected by first device 210 utilizing networks such as 2G, 3G, 4G, WiFi, Zigbee, Bluetooth, Ethernet, USB, SDIO or any other wireless or wired communication protocol.

Continuing with action 320 of FIG. 3, action 320 includes transmitting, using the processor of the device, the plurality of user account information for each of the plurality of electronic payment processors, respectively. According to the implementation shown in FIG. 2A, for example, action 320 may correspond to first device 210 transmitting the plurality of user account information for each of the user's credit cards directly to the electronic payment processor to which that particular user account belongs. Where appropriate, action 320 may only transmit a subset of the digits of the user's account number necessary to identify the electronic payment processor's identity. In such an example, the electronic payment processor may utilize the other user account information to match a user to a specific account with that particular electronic payment processor. This action may be carried out for each of the plurality of electronic payment processors stored in first device 210, for example. In the alternative, where a central device is utilized, first device 210 may transmit the plurality of user account information to central site server 230 for subsequent transmission to each of the plurality of electronic payment processors. In such an implementation, where a particular electronic payment processor does not wish to communicate through central site server 230, first device 210 may also transmit the required user account information directly to that particular electronic payment processor.

Moving to action 330 of FIG. 3, action 330 includes receiving, using the processor of the device, account statistics from two or more of the plurality of electronic payment processors in response to the transmitting of the plurality of user account information. According to the implementation shown in FIG. 2A, for example, action 330 may be carried out by first device 210 by way of receiver 212 and processor 216. Using the plurality of user information transmitted in action 320, each of the plurality of electronic payment processors may identify the particular user and provide account statistics specific to the account associated with that particular user. Examples of such account statistics may be total credit, current balance, remaining credit, one or more interest rates, and may even include one or more incentive quotes including pre-existing incentives associated with that particular electronic payment processor and/or user account. The plurality of user information may also include any other statistical information that may be associated with a user's account from an electronic payment processor.

These account statistics may be transmitted from each of the respective electronic payment processors and received directly by first device 210. In the alternative, where a central site server 230 is utilized, the plurality of account statistics may be transmitted from each of the electronic payment processors to central site server 230. Central site server 230 may then forward the account statistics or incentives to first device 210. In such an implementation, where a particular electronic payment processor does not wish to communicate through central site server 230, that particular electronic payment processor may transmit the account statistics directly to first device 210.

Continuing with action 340 of FIG. 3, action 340 includes displaying the account statistics from the two or more of the plurality of electronic payment processors on a display of the device. According to the implementation shown in FIG. 2A, for example, action 340 may correspond to first device 210 displaying the account statistics on display 218 for the user. Thus, the account statistics from the at least two of the plurality of electronic payment processors may be viewed and compared side by side. In this way the user may be apprised of the status of each of his or her accounts. To this point, such a method allows a user to simultaneously determine the status of each of his or her accounts associated with each of the electronic payment processors at any time and without the need for any purchase to take place.

From this point, the user may optionally use the displayed account statistics to make an informed decision as to which electronic payment processor or processors to use in initiating any potential future transaction. If such option is taken by the user, actions 350 and 360 may follow.

Optional action 350 of FIG. 3 includes receiving, by the processor of the device, a selection of one or more of the plurality of electronic payment processors by the user for processing a potential transaction. Thus, after checking the account statistics, and optional pre-existing incentive quotes, associated with each of the plurality of electronic payment processors, a user may decide that he or she would like to make a purchase or conduct a transaction. According to the implementation shown in FIG. 2A, for example, action 350 may correspond to the user providing an input to first device 210, through the input/output module 217 and captured by processor 216, in response to the account statistics displayed on display 218. The selection by the user corresponds to a selection of one or more of the plurality of electronic payment processors which the user has determined to be most desirable in the particular situation, based at least in part on the displayed account statistics. Because more than one of the plurality of electronic payment processors may be selected by the user, the user may additionally split the amount of any purchase or transaction between the more than one selected electronic payment processors as he or she sees fit. Thus, a user may receive multiple incentives, if quoted along with the account statistics, simply by selecting more than one electronic payment processor for a subsequent transaction.

Optional action 360 of FIG. 3 includes transmitting, by the processor of the device, the selection of the one or more of the plurality of electronic payment processors for processing the potential transaction. According to the implementation shown in FIG. 2A, for example, action 360 may correspond to first device 210 transmitting by way of transmitter 214, and controlled by processor 216, the selection or selections made by the user corresponding to the chosen electronic payment processor or processors. Included in the transmitted selection may be the plurality of account information corresponding to the one or more selected electronic payment processors and assigned to the user. The selection may be transmitted from first device 210 directly to one of several devices.

First device 210 may transmit the selection directly to POS terminal 220 in the case of a purchase, for example. This selection may operate to initiate a transaction by processing a payment through the one or more electronic payment processors selected by the user. In such a case, POS terminal 220 may then transmit the plurality of account information corresponding to the chosen one or more electronic payment processors directly to the respective electronic payment processor.

In the alternative, where a central device is utilized, first device 210 may transmit the selection or selections made by the user directly to central site server 230. Central site server 230 may then forward the selection which may include the plurality of account information corresponding to the chosen one or more electronic payment processors directly to the respective electronic payment processor to initiate the transaction. In such a case, the transmission may also be transmitted to POS terminal 220 via either first device 210 or via central site server 230.

In yet another alternative, where a central site server is not used or where a chosen electronic payment processor does not wish to communicate through central site server 230, the selection made by the user may be transmitted from first device 210 directly to the chosen one or more of the plurality of electronic payment processors. This transmission may likewise serve to initiate the transaction. In such a case, the transmission may also be transmitted to POS terminal 220 via first device 210.

Thus, according to a first implementation, as described above, a method of electronically soliciting user incentives and account statistics from a plurality of electronic payment processors may be realized. According to the above implementation, no purchase or tentative transaction is required to carry out the method including actions 310 through 340. Thus, a user may be apprised of the statistics as well as any pre-existing incentives associated with all of his or her credit cards or bank accounts at the same time.

Such a method is advantageous to the user, electronic payment processors, and retailer alike. The user is able to become apprised of the status of each of his credit card or bank accounts and may be further able to make informed decisions as to which of the electronic payment processors will offer him or her the most desirable incentives in exchange for using a particular payment processor for any future transactions. Each of the electronic payment processors may enjoy an added opportunity to convince the user to choose that particular electronic payment processor for future transactions. Also, any prospective retailers may benefit from the increased propensity of the user to purchase which may come with knowing the particular account statistics regarding each account with which he or she is associated.

A second exemplary implementation will now be described with reference to FIGS. 1C-1H, 2A-2C and 3. The second exemplary implementation is similar to the first exemplary implementation above, except that the user may primarily interface directly with a kiosk terminal 270, such as a stand-alone kiosk device in a mall, or integrated along side a POS terminal. This second exemplary implementation may also include a configuration where the user primarily interfaces directly with a POS terminal. Thus, anywhere a kiosk device is performing an action, this implementation may alternatively include a configuration where the action is performed, instead, by a POS terminal such as POS terminal 220, for example.

In the second implementation, action 310 of flowchart 300 includes retrieving, using a processor of a device, from a memory of the device, a plurality of user account information assigned to the user for each of the plurality of electronic payment processors, respectively. For the purposes of this implementation, action 310 may be carried out by kiosk terminal 270. The plurality of user account information may be retrieved either directly from the user utilizing input/output module 277 or may be retrieved from a first device 210, such as the user's smartphone, for example, as described previously regarding action 310 of the first implementation. Such a retrieval from first device 210 may be further accomplished by NFC protocols, 2G, 3G, 4G, WiFi, Zigbee, Bluetooth, Ethernet, USB, SDIO or any other wireless or wired communication protocol.

Continuing with action 320 of FIG. 3, action 320 includes transmitting, using the processor of the device, the plurality of user account information for each of the plurality of electronic payment processors, respectively. Action 320 may correspond to kiosk terminal 270 transmitting the plurality of user account information for each of that user's credit cards directly to the electronic payment processor to which that particular user account belongs. In the alternative, where a central device is utilized, kiosk terminal 270 may transmit the plurality of user account information to central site server 230 for subsequent transmission to each of the plurality of electronic payment processors. In such an implementation, where a particular electronic payment processor does not wish to communicate through central site server 230, kiosk terminal 270 may also transmit the required user account information directly to that particular electronic payment processor.

Moving to action 330 of FIG. 3, action 330 includes receiving, using the processor of the device, account statistics from two or more of the plurality of electronic payment processors in response to the transmitting of the plurality of user account information. Action 330 may be carried out by kiosk terminal 270 by way of receiver 272 and processor 276. Using the plurality of user information transmitted in action 320, each of the plurality of electronic payment processors may identify the particular user and provide account statistics specific to the account associated with that particular user. In the alternative, where a central site server 230 is utilized, the account statistics may be transmitted from each of the electronic payment processors to central site server 230. Central site server 230 may then forward the information to kiosk device 270. If a particular electronic payment processor does not wish to communicate through central site server 230, that particular electronic payment processor may transmit the required user account information directly to kiosk terminal 270.

Continuing with action 340 of FIG. 3, action 340 includes displaying the account statistics from the two or more of the plurality of electronic payment processors on a display of the device. Action 340 may correspond to kiosk terminal 270 displaying the account statistics from each of the plurality of electronic payment processors on its display for the user. Thus, each of the account statistics from the at least one of the plurality of electronic payment processors may be viewed and compared side by side. In this way the user may be apprised of the status of each of his or her accounts. As with the first implementation disclosed above, to this point, such a method allows a user to simultaneously determine the status of each of his or her accounts associated with each of the electronic payment processors at any time.

From this point, the user may optionally use the displayed account statistics to make an informed decision as to which electronic payment processor or processors to use in initiating any potential future transaction. If such option is taken by the user, actions 350 and 360 may follow. Actions 350 and 360, if performed with the utilization of kiosk terminal 270, would allow kiosk terminal 270 to act essentially as a POS terminal.

Optional action 350 of FIG. 3 includes receiving, by the processor of the device, a selection of one or more of the plurality of electronic payment processors by the user for processing a potential transaction. Action 350 may correspond to the user providing an input to kiosk terminal 270 utilizing input/output module 277 for example, in response to the account statistics on the kiosk display.

Optional action 360 of FIG. 3 includes transmitting, by the processor of the device, the selection of the one or more of the plurality of electronic payment processors for processing the potential transaction. Action 360 may be carried out by kiosk terminal 270. In the alternative, where a central device such as central site server 230 is also employed, kiosk terminal 270 may transmit the selection to central site server 230 which may then forward the necessary information as disclosed regarding optional action 360 of the first implementation above. If a particular electronic payment processor does not wish to communicate through central site server 230, kiosk terminal 270 may also transmit the selection directly to that particular electronic payment processor.

Thus, according to a second implementation, as described above, a method of electronically soliciting user incentives and account statistics from a plurality of electronic payment processors may be realized. According to the above implementation, no purchase or tentative transaction is required to carry out the method including actions 310 through 340. Thus, a user may be apprised of the statistics as well as any pre-existing incentives associated with all of his or her credit cards or bank accounts at the same time.

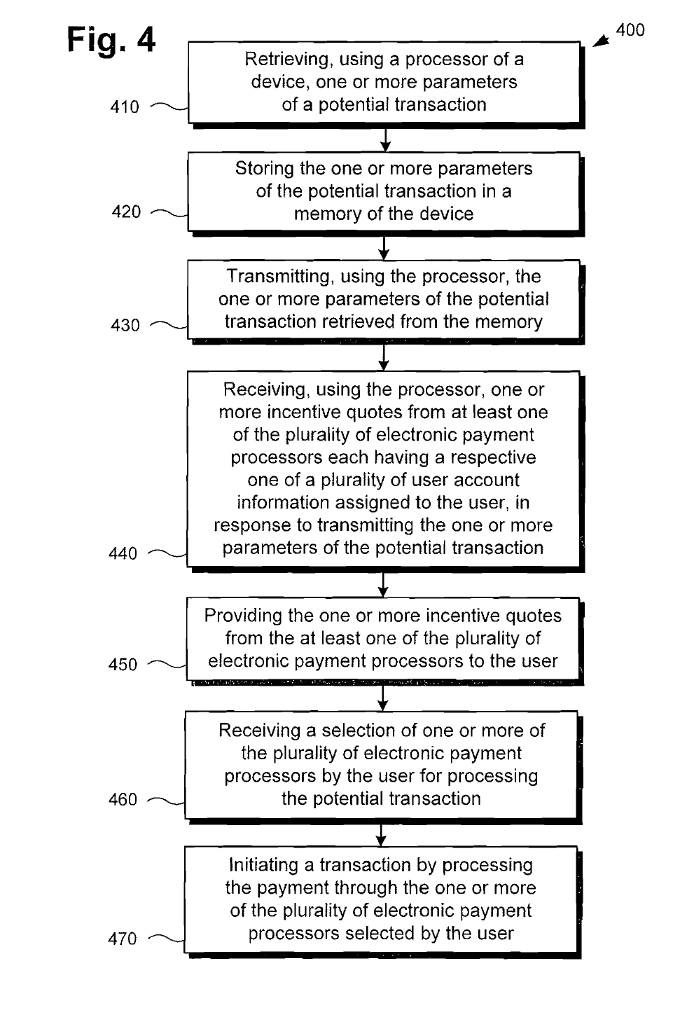

A third exemplary implementation will now be described with reference to FIGS. 1C-1H, 2A-2C and 4. FIG. 4 shows a flowchart describing an exemplary implementation of a method for electronically soliciting user incentives and account statistics from a plurality of electronic payment processors. By this third implementation, a user primarily interfaces directly with a first device 210, such as the user's smartphone, PDA, PC, or any other or any other suitable device capable of being secured or unsecured wireless or wired communication via a network, for example.

In the third implementation, action 410 includes retrieving, using a processor of a device, one or more parameters of a potential transaction. Thus, as shown in FIG. 2A, first device 210, for example, may retrieve one or more parameters of a potential transaction, utilizing processor 216. Here, first device 210 may be a mobile phone, a PC, a PDA, or any other suitable device capable of wireless or wired communication. The one or more parameters of a potential transaction may be an amount of the transaction, a merchant identity, an identification of goods or services, an identification of a type of goods and services, or a manufacturer identity of a purchased item, etc.

First device 210 may retrieve the one or more parameters of the potential transaction from any of several sources. The one or more parameters of the potential transaction may be retrieved from a POS terminal 220, which may include a POS terminal in a retail store, for example. Optionally, such retrieval may utilize NFC protocols, 2G, 3G, 4G, WiFi, Zigbee, Bluetooth, Ethernet, USB, SDIO or any other wireless or wired communication protocol. In the alternative, the one or more parameters of the potential transaction may be retrieved directly from the user by way of manual entry to first device 210 utilizing input/output module 217. Where a central device is utilized, first device 210 may retrieve the one or more parameters of the potential transaction directly from central site server 230 in addition to or in substitution of one of the above sources of retrieval.

Continuing with action 420 of FIG. 4, action 420 includes storing the one or more parameters of the potential transaction in a memory of the device. With reference to FIG. 2A, first device 210 may store the retrieved one or more parameters of the potential transaction in memory 215 for later use.

Moving to action 430 of FIG. 4, action 430 includes transmitting, using the processor, the one or more parameters of the potential transaction retrieved from the memory. According to the implementation shown in FIG. 2A, for example, action 430 may correspond to first device 210 utilizing transmitter 214 and processor 216 to transmit the one or more parameters of a potential transaction directly to each of the electronic payment processors 140 with which a user is associated. First device 210 may include information identifying the user, such as the user's unique credit card or bank account number, as a part of the one or more parameters of the potential transaction sent to each electronic payment processor in order to allow each of the electronic payment processors to identify the user and formulate one or more incentive quotes. In the alternative, where a central device is utilized, first device 210 may transmit this information to a central site server 230 which may then forward or transmit the information to each of the electronic payment processors associated with that particular user. If a particular electronic payment processor does not wish to communicate through central site server 230, first device 210 may transmit the information directly to that particular electronic payment processor.

Action 440 of FIG. 4 includes receiving, using the processor, one or more incentive quotes from at least one of the plurality of electronic payment processors each having a respective one of a plurality of user account information assigned to the user, in response to transmitting the one or more parameters of the potential transaction. Thus, after each of the electronic payment processors receives one or more parameters of a potential transaction from the user identifying the important aspects of the potential transaction, each of the electronic payment processors may transmit back one or more incentive quotes designed to entice the user to choose that particular electronic payment processor to fund the payment for the potential transaction. These incentive quotes may be transmitted directly to first device 210. In the alternative, where a central device, such as central site server 230, is employed, the incentive quotes may be transmitted to central site server 230, which then forwards or transmits each of the incentive quotes to first device 210. If a particular electronic payment processor does not wish to communicate through central site server 230, that particular electronic payment processor may transmit the incentive quotes directly to first device 210.

These incentive quotes may be generic, such that every user of a particular electronic payment processor would receive the same incentive. The incentive quotes may be specific to a particular user or consumer, such that a particular electronic payment processor may tailor the incentive quote to the users unique credit history, to-date incentive accrual, purchasing habits, credit score, or any other useful metric. The incentive quotes may also include specific retailer incentives, provided by either the electronic payment processor or by a retailer itself when a potential transaction is between the user and a particular retailer or when the potential transaction is for a product from a particular manufacturer. Examples of retailer incentives may include a percentage off the purchase price if a retailer credit card account is opened and/or used by the user to complete a purchase. The incentive quotes may also be specific to a particular product or to a particular manufacturer. However, any combination of the above categories of incentive quotes may be used and may further include account statistics pertaining to an account with a particular electronic payment processor. Examples of such account statistics may include an account balance, a total credit line amount, a remaining credit amount, an amount of accrued incentives, one or more interest rates, or any other information that may be associated with a user's account from an electronic payment processor.

The above categories of incentive quotes are exemplary and should not be considered all inclusive or limiting. Additionally, each of the above examples of incentive quotes may further be customized with respect to the specific consumer or with respect to other incentive quotes offered by competing electronic payment processors. Thus, each electronic payment processor may have the opportunity to modify an incentive quote at the time of a real-time purchase or other contemplated future transaction.

Continuing with action 450 of FIG. 4, action 450 includes providing the one or more incentive quotes from the at least one of the plurality of electronic payment processors to the user. Action 450 may correspond to first device 210 displaying the incentive quotes on display 218 for the user as disclosed in FIG. 2A and as further elaborated by FIGS. 2B and 2C. Thus, each of the incentive quotes from the at least one of the plurality of electronic payment processors may be viewed by the user side by side. The user may then make an informed decision as to which one or more of the electronic payment processors to use in initiating the potential transaction.

Moving to action 460 of FIG. 4, action 460 includes receiving a selection of the one of the plurality of electronic payment processors by the user for processing the potential transaction. Thus, action 460 may correspond to the user providing an input to first device 210, utilizing input/output module 217 for example, in response to the incentive quotes on display 218 and corresponding to a selection of one or more of the plurality of electronic payment processors which the user has determined to be most desirable in the particular situation, based on the displayed incentive quotes. Because more than one of the plurality of electronic payment processors may be selected by the user, the user may additionally split the amount of any purchase or transaction between the more than one selected electronic payment processors as he or she sees fit. Thus, a user may receive multiple incentives simply by selecting more than one electronic payment processor for processing the potential transaction.

Action 470 of FIG. 4 includes initiating a transaction by processing the payment through the one or more of the plurality of electronic payment processors selected by the user. Here, once the user has made a selection as to which one or more electronic payment processors he or she will use, the transaction may be initiated by sending the user's account information, pertaining to the one or more chosen electronic payment processors from first device 210, to POS terminal 220, for example, which will process the payment through the chosen electronic payment processor.

Thus, according to a third implementation, a method of electronically soliciting user incentives and account statistics from a plurality of electronic payment processors may be realized. The user is able to make an informed decision as to which payment processor or processors will offer him or her the most desirable incentive in exchange for using that particular payment processor for a particular potential transaction. Each of the payment processors may enjoy an added opportunity to convince the user to choose that particular payment processor each time a potential transaction is made by the user. And a prospective retailer may benefit from the increased propensity of the user to purchase which may result from being continually offered competitive incentives from one or more of the user's electronic payment processors.

A fourth exemplary implementation will now be described, again, with reference to FIGS. 1C-1D, 1G-1H, 2A-2C and 4. The fourth implementation is similar to the third implementation above, except that the user will primarily interface directly with a POS terminal 220, such as a POS terminal. In a fourth implementation, action 410 includes retrieving, using a processor of a device, one or more parameters of a potential transaction. In this implementation action 410 may be carried out by POS terminal 220, which may be a retail POS terminal for example. POS terminal 220 may retrieve the one or more parameters of a potential transaction, utilizing processor 226, as calculated during checkout, for example. If POS terminal 220 is the POS terminal on which the potential transaction is being executed, or “rung up”, the retrieval may occur within POS terminal 220.

Continuing with action 420 of FIG. 4, action 420 includes storing the one or more parameters of the potential transaction in a memory of the device. Action 420 may be carried out by POS terminal 220 which may store the retrieved one or more parameters of the potential transaction in memory 225 for later use.

Moving to action 430 of FIG. 4, action 430 includes transmitting, using the processor, the one or more parameters of the potential transaction retrieved from the memory. Action 430 may correspond to POS terminal 220 utilizing transmitter 224 and processor 226 to transmit the one or more parameters of the potential transaction directly to each of the electronic payment processors 140 with which a user is associated. POS terminal 220 may include information identifying the user, such as the user's unique credit card or bank account number as a part of the one or more parameters of the potential transaction sent to each electronic payment processor in order to allow each of the electronic payment processors to identify the user and formulate one or more incentive quotes. In the alternative, where a central device is utilized, POS terminal 220 may transmit this information to a central site server 230 which may then forward or transmit the information to each of the electronic payment processors associated with that particular user. If a particular electronic payment processor does not wish to communicate through central site server 230, POS terminal 220 may transmit the information directly to that particular electronic payment processor.

Action 440 of FIG. 4 includes receiving, using the processor, one or more incentive quotes from at least one of the plurality of electronic payment processors each having a respective one of a plurality of user account information assigned to the user, in response to the transmission of the one or more parameters of the potential transaction. Thus, after each of the electronic payment processors receives one or more parameters of a potential transaction from the user identifying the important aspects of the potential transaction to be auctioned, each of the electronic payment processors may transmit back one or more incentive quotes designed to entice the user to choose that particular electronic payment processor to fund the payment for the potential transaction. These incentive quotes may be transmitted directly to POS terminal 220, as the retail POS terminal, for example. In the alternative, where a central device, such as central site server 230, is employed, the incentive quotes may be transmitted to central site server 230, which then forwards or transmits each of the incentive quotes to POS terminal 220. If a particular electronic payment processor does not wish to communicate through central site server 230, that particular electronic payment processor may transmit the incentive quotes directly to POS terminal 220.

Continuing with action 450 of FIG. 4, action 450 includes providing the one or more incentive quotes from the at least one of the plurality of electronic payment processors to the user. Action 450 may correspond to second device 210 utilizing display 228 to provide a graphical user interface displaying each of the incentive quotes to the user. Thus, each of the incentive quotes from the at least one of the plurality of electronic payment processors may be viewed by the user side by side on the POS terminal itself, for example, such that the user may make an informed decision as to which one or more electronic payment processors to use in initiating the potential transaction.

Moving to action 460 of FIG. 4, action 460 includes receiving a selection of the one of the plurality of electronic payment processors by the user for processing the potential transaction. Thus, action 460 may correspond to the user providing an input to POS terminal 220, utilizing input/output module 227 and in response to the incentive quotes on display 228. The input provided corresponds to a selection of one or more of the plurality of electronic payment processors which the user has determined to be most desirable in the particular situation, based on the displayed incentive quotes. Because more than one of the plurality of electronic payment processors may be selected by the user, the user may additionally split the amount of any purchase or transaction between the more than one selected electronic payment processors as he or she sees fit. Thus, a user may receive multiple incentives simply by selecting more than one electronic payment processor for a initiating the potential transaction.

Action 470 of FIG. 4 includes initiating a transaction by processing the payment through the one or more of the plurality of electronic payment processors selected by the user. This action may be carried out just as is done regarding action 470 of the third exemplary implementation described above and so will not be discussed in detail here. Thus, according to a fourth exemplary implementation, a method of electronically soliciting user incentives and account statistics from a plurality of electronic payment processors may be realized. The above method according to the fourth implementation may be implemented by any of the systems disclosed in FIGS. 1E-1H.

A fifth exemplary implementation will now be described, again, with reference to FIGS. 1E-1H, 2A-2C and 4. The fifth exemplary implementation is similar to the third and fourth exemplary implementations above, except that the user will primarily interface directly with a kiosk terminal 270, such as a stand-alone kiosk device in a mall or integrated along side a POS terminal.

In a fifth exemplary implementation, action 410 includes retrieving, using a processor of a device, one or more parameters of a potential transaction. In this implementation action 410 may be carried out by a kiosk terminal 270, utilizing processor 276, which may be a may be separate from a POS terminal. Kiosk terminal 270 may retrieve the one or more parameters of a potential transaction as calculated during checkout from a POS terminal, such as POS terminal 220 for example.

Continuing with action 420 of FIG. 4, action 420 includes storing the one or more parameters of the potential transaction in a memory of the device. Action 420 may be carried out by kiosk terminal 270 which may store the retrieved one or more parameters of the potential transaction in its memory for later use.

Moving to action 430 of FIG. 4, action 430 includes transmitting, using the processor, the one or more parameters of the potential transaction retrieved from the memory. Action 430 may correspond to kiosk terminal 270 utilizing transmitter 274 and processor 276 to transmit the one or more parameters of the potential transaction directly to each of the electronic payment processors 140 with which a user is associated. This action may be carried out by kiosk terminal 270 just as is done by POS terminal 220 regarding action 430 of the third exemplary implementation described above and so will not be discussed again in detail here. In the alternative, where a central device is utilized, kiosk terminal 270 may transmit this information to a central site server 230 which may then forward or transmit the information to each of the electronic payment processors associated with that particular user. If a particular electronic payment processor does not wish to communicate through central site server 230, kiosk terminal 270 may transmit the information directly to that particular electronic payment processor.

Action 440 of FIG. 4 includes receiving, using the processor, one or more incentive quotes from at least one of the plurality of electronic payment processors each having a respective one of a plurality of user account information assigned to the user, in response to the transmission of the one or more parameters of the potential transaction. These incentive quotes may be transmitted directly to kiosk terminal 270. In the alternative, where a central device, such as central site server 230, is employed, the incentive quotes may be transmitted to central site server 230, which then forwards or transmits each of the incentive quotes to kiosk terminal 270. If a particular electronic payment processor does not wish to communicate through central site server 230, that particular electronic payment processor may transmit the information directly to kiosk terminal 270.

Continuing with action 450 of FIG. 4, action 450 includes providing the one or more incentive quotes from the at least one of the plurality of electronic payment processors to the user. Action 450 may correspond to first device 210 displaying the incentive quotes on display 218 for the user as disclosed in FIG. 2A and as further elaborated by FIGS. 2B and 2C. Thus, each of the incentive quotes from the at least one of the plurality of electronic payment processors may be viewed by the user side by side on the kiosk device itself. The user may then make an informed decision as to which one or more electronic payment processors to use in initiating the potential transaction.

Moving to action 460 of FIG. 4, action 460 includes receiving a selection of one or more of the plurality of electronic payment processors by the user for processing the potential transaction. Thus, similar to action 350 of flowchart 300, action 460 may correspond to the user providing an input to kiosk terminal 270 utilizing input/output module 277, for example, and in response to the incentive quotes on display 278. Because more than one of the plurality of electronic payment processors may be selected by the user, the user may additionally split the amount of any purchase or transaction between the more than one selected electronic payment processors as he or she sees fit. Thus, a user may receive multiple incentives simply by selecting more than one electronic payment processor for a subsequent transaction.

Action 470 of FIG. 4 includes initiating a transaction by processing the payment through the one or more of the plurality of electronic payment processors selected by the user. This action may be carried out just as is done regarding action 470 of the third and fourth exemplary implementations described above and so will not be discussed in detail here. Thus, according to a fifth exemplary implementation, a method of electronically soliciting user incentives and account statistics from a plurality of electronic payment processors may be realized. The above method according to the fifth implementation may be implemented by any of the systems disclosed in FIGS. 1E-1H.

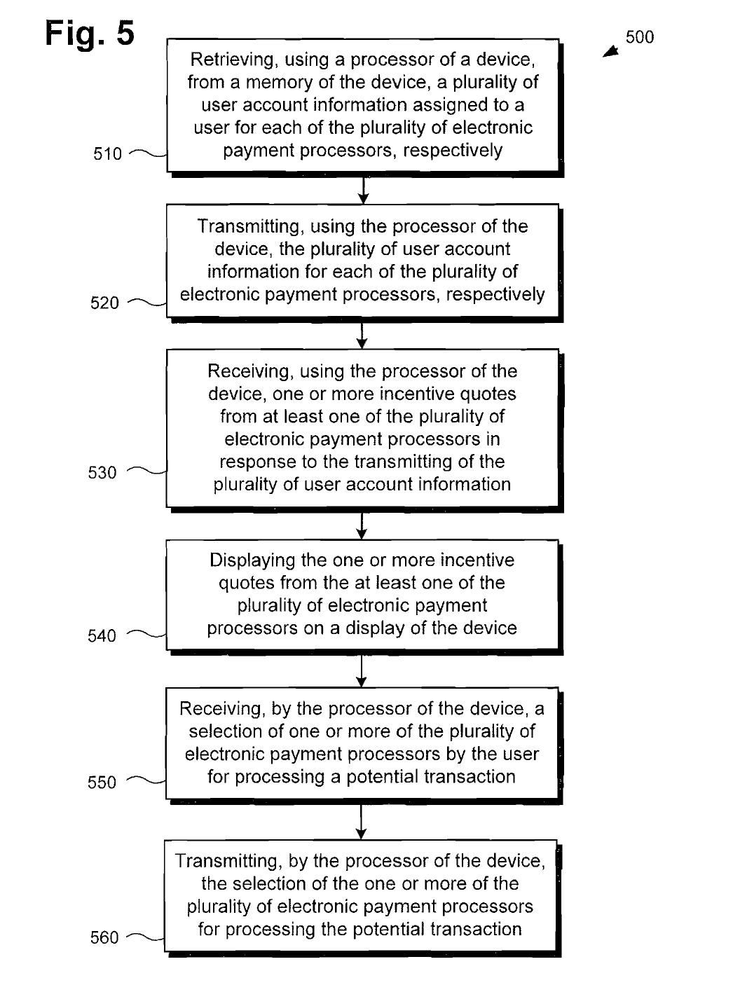

A sixth exemplary implementation will now be described with reference to FIGS. 1C-1D, 1G-1H, 2A-2C and 5. FIG. 5 shows a flowchart describing an exemplary implementation of another method for electronically soliciting user incentives and account statistics from a plurality of electronic payment processors. By this sixth implementation, a user primarily interfaces directly with a first device 210, such as the user's smartphone, PDA, PC, or any other or any other suitable device capable of being secured or unsecured wireless or wired communication via a network, for example.

Actions 510 and 520 of flowchart 500 may be implemented substantially as disclosed in actions 310 and 320 of flowchart 300 describing the first implementation above and thus will not be described again in detail.

Moving to action 530 of FIG. 5, action 530 includes receiving, using the processor of the device, one or more incentive quotes from at least one of the plurality of electronic payment processors in response to the transmitting of the plurality of user account information. Action 330 may be carried out by first device 210 by way of receiver 212 and processor 216. Thus, after each of the electronic payment processors receives the plurality of user account information, each of the electronic payment processors may transmit back one or more incentive quotes designed to entice the user to choose that particular electronic payment processor to fund the payment for the potential transaction. These incentive quotes may be designed as disclosed previously regarding action 440 of the third implementation above.

These incentive quotes may be transmitted from each of the respective electronic payment processors and received directly by first device 210. In the alternative, where a central site server 230 is utilized, the incentive quotes may be transmitted from each of the electronic payment processors to central site server 230. Central site server 230 may then forward the incentives to first device 210. If a particular electronic payment processor does not wish to communicate through central site server 230, that particular electronic payment processor may transmit the information directly to first device 210.

Continuing with action 540 of FIG. 5, action 540 includes displaying the one or more incentive quotes from the at least one of the plurality of electronic payment processors on a display of the device. Action 540 may correspond to first device 210 displaying the incentive quotes on display 218 for the user as disclosed in FIG. 2A and as further elaborated by FIGS. 2B and 2C. Thus, the incentive quotes from the one or more of the plurality of electronic payment processors may be viewed and compared side by side by the user.

Actions 550 and 560 of flowchart 500 may be implemented substantially as disclosed in actions 350 and 360 of flowchart 300 describing the first implementation above and thus will not be described again in detail.

Thus, according to a sixth implementation, as described above, a method of electronically soliciting user incentives and account statistics from a plurality of electronic payment processors may be realized.

A seventh exemplary implementation will now be described with reference to FIGS. 1C-1H, 2A, 2C and 5. The seventh exemplary implementation is similar to the sixth exemplary implementation above, except that the user may primarily interface directly with a kiosk terminal 270, such as a stand-alone kiosk device in a mall or integrated along side a POS terminal. This seventh exemplary implementation may alternatively include a configuration where the user primarily interfaces directly with a POS terminal. Thus, anywhere a kiosk device is performing an action, this implementation may also include a configuration where the action is performed, instead, by a POS terminal such as POS terminal 220, for example.

In the seventh implementation, action 510 of flowchart 300 includes retrieving, using a processor of a device, from a memory of the device, a plurality of user account information assigned to the user for each of the plurality of electronic payment processors, respectively. For the purposes of this implementation, action 510 may be carried out by kiosk terminal 270. The plurality of user account information may be retrieved either directly from the user or may be retrieved from a first device 210, such as the user's smartphone, for example, as described previously regarding action 310 of the first and second implementations. This retrieval may be further accomplished by NFC protocols, 2G, 3G, 4G, WiFi, Zigbee, Bluetooth, Ethernet, USB, SDIO or any other wireless or wired communication protocol.

Continuing with action 520 of FIG. 5, action 520 includes transmitting, using the processor of the device, the plurality of user account information for each of the plurality of electronic payment processors, respectively. Action 520 may correspond to kiosk terminal 270 transmitting the plurality of user account information for each of that user's credit cards directly to the electronic payment processor to which that particular user account belongs. In the alternative, where a central device is utilized, kiosk terminal 270 may transmit the plurality of user account information to central site server 230 for subsequent transmission to each of the plurality of electronic payment processors. If a particular electronic payment processor does not wish to communicate through central site server 230, kiosk terminal 270 may transmit the information directly to that particular electronic payment processor.

Moving to action 530 of FIG. 5, action 530 includes receiving, using the processor of the device, one or more incentive quotes from at least one of the plurality of electronic payment processors in response to the transmitting of the plurality of user account information. Action 530 may be carried out by kiosk terminal 270 by way of receiver 272 and processor 276. Thus, after each of the electronic payment processors receives the plurality of user account information, each of the electronic payment processors may transmit back one or more incentive quotes designed to entice the user to choose that particular electronic payment processor to fund the payment for the potential transaction. These incentive quotes may be designed as disclosed previously regarding action 440 of the third implementation above.

These incentive quotes may be transmitted from each of the respective electronic payment processors and received directly by kiosk terminal 270. In the alternative, where a central site server 230 is utilized, the incentive quotes may be transmitted from each of the electronic payment processors to central site server 230. Central site server 230 may then forward the incentives to kiosk terminal 270. If a particular electronic payment processor does not wish to communicate through central site server 230, that particular electronic payment processor may transmit the information directly to kiosk terminal 270.

Continuing with action 540 of FIG. 5, action 540 includes displaying the one or more incentive quotes from the at least one of the plurality of electronic payment processors on a display of the device. Action 540 may correspond to kiosk terminal 270 displaying the account statistics on display 278 for the user as disclosed in FIG. 2A and as further elaborated by FIGS. 2B and 2C. Thus, the incentive quotes from the plurality of electronic payment processors may be viewed and compared side by side by the user.

Actions 550 and 560 of flowchart 500 may be implemented substantially as disclosed in actions 350 and 360 of flowchart 300 describing the first implementation above and thus will not be described again in detail.

Thus, according to a seventh implementation, as described above, a method of electronically soliciting user incentives and account statistics from a plurality of electronic payment processors may be realized.

Several specific examples incorporating one or more devices utilizing one or more of the above implemenations will now be described for further clarification. In a first example, a user may be interested in checking how much credit and at what interest rate each of his 6 credit cards are currently available to him. The user opens an application on his smartphone which is preprogramed with his user account information for each of his 6 credit cards. He instructs the application to show him the account statistics available for each of his 6 credit cards. His smartphone transmits the user account information for each of his 6 credit cards to the respective credit card companies' servers. Each of the credit card companies' servers use this user account information to identify the user and transmits the relevant account statistics back to the user's smartphone. The application on the user's smartphone displays the account statistical information for each of the user's 6 credit card accounts on his phone simultaneously. The user can then compare each of his accounts side by side according to any number of account statistics, including but not limited to, balance, current interest rates, current incentives available or accrued, and spending habit allocations, for example.

In a second example, a user walking in the mall is curious as to how much credit and at what interest rate each of his 6 credit cards are currently available to him. The user walks over to a kiosk terminal located in the mall which runs an application which performs one or more methods of according to one or more of the above implementations of the present disclosure. The user manually enters his user account information regarding each of his 6 credit card or bank account numbers. In the alternative, the user may use his smartphone, which is preprogramed with his user account information for each of his 6 credit cards, to transfer this information to the kiosk terminal via NFC protocols. He instructs the application on the kiosk terminal to show him the account statistics available for each of his 6 credit cards. The kiosk terminal transmits the user account information for each of his 6 credit cards to the respective credit card companies' servers. Each of the credit card companies' servers use this user account information to identify the user and transmits the relevant account statistics back to the user's smartphone. The application on the user's smartphone displays the account statistical information for each of the user's 6 credit card accounts on the display of the kiosk terminal. The user can then compare each of his accounts side by side according to any number of account statistics, including but not limited to, balance, current interest rates, current incentives available or accrued, and spending habit allocations, for example.

In a third example, a consumer is considering setting up an automatic bill pay for monthly expenses, or to transfer a balance from a particular credit card. The consumer may access an application utilizing the above method on his mobile phone, PDA, or PC to auction the monthly payments or balance transfer. The consumer may first enter his account information corresponding to each electronic payment processor with which he is associated using the application. Account information identifying the particular user along with information indicating the monthly payment amounts, or the balance to be transferred along with a classification of “scheduled payment” or “balance transfer”, for example, may be retrieved from the memory of the consumer's device and transmitted securely from the consumer's device to a central server which then transmits the information to each of the credit card companies with which the consumer has an account.

Each of the credit card companies or banks may then formulate one or more incentive quotes designed to entice the consumer to choose a particular credit card company or bank to perform the monthly payments or to transfer the balance to. Each incentive quote is then transmitted securely to the central server and the central server transmits each quote to the consumer's device. The consumer's device will then display each of the incentive quotes side by side on the device display. The consumer may then choose which electronic payment processor or processors he would like to use for the monthly payments or balance transfer based on which incentive has the highest perceived value to the consumer at the time. The consumer makes selection via the application on the device. The consumer's selection is transmitted to the chosen electronic payment processor and the monthly payments or the balance transfer are performed by the chosen electronic payment processor at the appropriate time. Once the payment or transfer has been executed, the consumer is credited the incentive quoted.

In a fourth example, a consumer may be shopping at a retail store for a flat-screen television. Upon checking out with the cashier, a POS terminal may “ring up” or scan the television at a price of $3,500. Utilizing NFC technology, for example, the POS terminal may transmit the price and designation of the item type to be purchased as “electronics” or “entertainment”. The information may be received by the consumer's smartphone, containing an application which supports one or more methods as described herein. The consumer's smartphone may then store the parameters of the television purchase in memory. The consumer's smartphone may then send the purchase parameters to all or a number of the credit card companies or banks with which the consumer has an account, referencing the consumer's account information which has previously been stored in the smartphone. The consumer shortly receives one or more incentive quotes based on the purchase parameters, from each of the credit card companies and/or banks on herher smartphone. For example, the consumer's DISCOVER card may offer 2% cash back on the purchase. The consumer's VISA card may offer 5000 bonus “miles” or “points” toward a free plane ticket. And the retailer itself may offer the consumer 5% off of the purchase if the consumer applies for the retailer's credit card and uses that card to purchase the television. These incentive quotes are displayed on the consumer's smartphone display for easy comparison. Because the consumer is planning to fly to see family shortly, the consumer may decide to purchase the television with the VISA card in order to use the incentive to receive the bonus miles. The consumer selects the VISA card on her mobile phone, which then sends the appropriate account information to the POS terminal, which completes the transaction using the consumer's VISA card information.

In a fifth example, a consumer is planning a 3-day trip to a family entertainment park. The cost of the trip is quoted at $1,000. Using a POS terminal or Kiosk terminal located in the mall, running an application which performs one or more methods as disclosed herein, parameters of the potential purchase of the trip are transmitted to each of the electronic payment processors with which the consumer has an account. One or more incentive quotes are then transmitted back to and received by the POS terminal or Kiosk terminal. Each of the incentive quotes are displayed on the display of the POS terminal or Kiosk terminal such that the consumer may perform a side-by-side comparison of all or a selection of the incentive quotes or simply view the accrual of current or existing incentives from each of the electronic payment processors. Based on the incentive quotes, the consumer may now select one of her electronic payment processors, or credit cards, to complete the purchase at a future date. So long as the terms of the trip to be purchased do not change, the chosen electronic payment processor will credit the chosen quoted incentive to the consumer when the transaction is completed. As an added benefit, even where the consumer does not choose a particular electronic payment processor, the unchosen electronic payment processor will still benefit from the data collected regarding the consumer's spending or purchasing habits. The above examples are intended to be illustrative only, and should not be construed as limiting any of the above disclosed implementations of the present disclosure in any way.

Thus, one or more of the various implementations described above allow a user to have a plurality of electronic payment processors, with which the user has an account, compete for his or her patronage. Further, a system or device according to one or more implementations disclosed herein may be capable of executing more than one method disclosed above. Thus, using one or more implementations of the present inventive concepts, a user will be enabled to make informed, real time or non-real time decisions as to which credit card, or other electronic payment processor to use for a particular purchase or transaction, based on his or her needs or desires with respect to one or more of the incentives offered, or with respect to statistics of his or her various accounts. Because the above implementations may be used each time a user is to make a potential transaction, each of the electronic payment processors enjoy the added advantage of having multiple potential opportunities each day to win the business of their account holders. Conventional methods of conducting purchases or transactions using electronic payment processors have been incapable of providing any of the above benefits or advantages, however, various implementations described above offer one or more such advantages.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the spirit and the scope of those concepts. As such, the described implementations are to be considered in all respects as illustrative and not restrictive. It should also be understood that the present application is not limited to the particular implementation described herein, but many rearrangements, modifications, and substitutions are possible without departing from the present disclosure.

What is claimed is:

1. A method of electronically soliciting account statistics from a plurality of electronic payment processors, the method comprising:
retreiving, using a processor of a device, a plurality of user account information assigned to a user for each of the plurality of electronic payment processors, respectively;
transmitting, using the processor of the device, the plurality of user account information for each of the plurality of electronic payment processors, respectively;
receiving, using the processor of the device, account statistics from two or more of the plurality of electronic payment processors in response to the transmitting of the plurality of user account information; and
displaying the account statistics from the two or more of the plurality of electronic payment processors on a display of the device.

2. The method of claim 1, further comprising:
receiving, by the processor of the device, a selection of one or more of the plurality of electronic payment processors by the user for processing a potential transaction, the selection based on the account statistics; and
transmitting, by the processor of the device, the selection of the one or more of the plurality of electronic payment processors for processing the potential transaction.

3. The method of claim 1, wherein the device is one of a mobile device, a personal computer, and a personal digital assistant, a point of sale terminal, and a kiosk terminal.

4. The method of claim 1, wherein the device is a mobile device utilizing near-field-communication for the transmitting of the plurality of user account information for each of the plurality of electronic payment processors, respectively, to a second device having information for the potential transaction.

5. The method of claim 4, wherein the second device is one of a point of sale terminal or a kiosk terminal.

6. The method of claim 1, wherein the plurality of electronic payment processors include one or more of American Express, Visa, MasterCard, Discover, Bankcard, China UnionPay, Diners Club, InstaPayment, JCB, Laser, Maestro, Solo, and Switch.

7. The method of claim 1, wherein the account statistics include one or more of an account balance, a total credit line amount, a remaining credit amount, an amount of accrued incentives, and one or more interest rates.

8. The method of claim 7, wherein the account statistics further include one or more incentive quotes comprising one or more pre-existing incentives.

9. A method of electronically soliciting user incentives from a plurality of electronic payment processors, the method comprising:
retreiving, using a processor of a device, a plurality of user account information assigned to the user for each of the plurality of electronic payment processors, respectively;
transmitting, using the processor of the device, the plurality of user account information for each of the plurality of electronic payment processors, respectively;
receiving, using the processor of the device, one or more incentive quotes from at least one of the plurality of electronic payment processors in response to the transmitting of the plurality of user account information; and
displaying the one or more incentive quotes from the at least one of the plurality of electronic payment processors on a display of the device.

10. The method of claim 9, further comprising:
receiving, by the processor of the device, a selection of one or more of the plurality of electronic payment processors by the user for processing a potential transaction, the selection based on the one or more incentive quotes; and
transmitting, by the processor of the device, the selection of the one of the plurality of electronic payment processors for processing the potential transaction.

11. The method of claim 9, wherein the device is one of a mobile device, a personal computer, a personal digital assistant, a point of sale terminal, and a kiosk terminal.

12. The method of claim 9, wherein the device is a mobile device utilizing near-field-communication for the transmitting of the plurality of user account information for each of the plurality of electronic payment processors, respectively, to a second device having information for the potential transaction.

13. The method of claim 12, wherein the second device is a point of sale terminal or a kiosk terminal.

14. The method of claim 9, wherein the plurality of electronic payment processors include one or more of American Express, Visa, MasterCard, Discover, Bankcard, China UnionPay, Diners Club, InstaPayment, JCB, Laser, Maestro, Solo, and Switch.

15. A method of electronically soliciting user incentives from a plurality of electronic payment processors, the method comprising:
receiving, using a processor of a device, one or more parameters of a potential transaction;
storing the one or more parameters of the potential transaction in a memory of the device;
transmitting, using the processor, the one or more parameters of the potential transaction retrieved from the memory;
receiving, using the processor, one or more incentive quotes from at least one of the plurality of electronic payment processors each having a respective one of a plurality of user account information assigned to the user, in response to the transmitting of the one or more parameters of the potential transaction; and
providing the one or more incentive quotes from the at least one of the plurality of electronic payment processors to the user.

16. The method of claim 15, further comprising:
receiving a selection of one or more of the plurality of electronic payment processors by the user for processing the potential transaction; and
initiating a transaction by processing the payment through the one or more of the plurality of electronic payment processors selected by the user.

17. The method of claim 15, wherein the device is one of a mobile device, a personal computer, a personal digital assistant, a point of sale terminal, and a kiosk terminal.

18. The method of claim 15, wherein the one or more parameters of the potential transaction includes one or more of an amount of the payment, a merchant identity, an identification of goods or services, and an identification of a type of goods and services.

19. The method of claim 15, wherein the incentive quotes further comprise account statistics including one or more of an account balance, a total credit line amount, a remaining credit amount, an amount of accrued incentives, and one or more interest rates.

20. A device for electronically soliciting user incentives and account statistics from a plurality of electronic payment processors, the device comprising:
a memory storing a plurality of user account information assigned to a user for each of the plurality of electronic payment processors, respectively;
a display;
a processor configured to:
retrieve from a memory of the device the plurality of user account information for each of the plurality of electronic payment processors, respectively;
transmit the plurality of user account information for each of the plurality of electronic payment processors, respectively;
receive one or more incentive quotes or account statistics from two or more of the plurality of electronic payment processors in response to the transmitting of the plurality of user account information; and
display the account statistics from the two or more of the plurality of electronic payment processors on the display.

21. The device of claim 20, wherein the processor is further configured to:
receive a selection of one or more of the plurality of electronic payment processors by the user for processing a potential transaction; and
transmit the selection of the one or more of the plurality of electronic payment processors for processing the potential transaction.

22. The device of claim 20, wherein the device is one of a mobile device, a personal computer, a personal digital assistant, a point of sale terminal, and a kiosk terminal.

23. The device of claim 20, wherein the device is a mobile device utilizing near-field-communication for transmitting the plurality of user account information for each of the plurality of electronic payment processors, respectively, to a second device having information for the potential transaction.

24. The device of claim 23, wherein the second device is one of a point of sale terminal or a kiosk terminal.

25. The device of claim 20, wherein the plurality of electronic payment processors include one or more of American Express, Visa, MasterCard, Discover, Bankcard, China UnionPay, Diners Club, InstaPayment, JCB, Laser, Maestro, Solo, and Switch.

26. A device for electronically soliciting user incentives and account statistics from a plurality of electronic payment processors, the device comprising:
a memory;
a processor configured to:
receive one or more parameters of a potential transaction;
store the one or more parameters of the potential transaction in the memory;
transmit the one or more parameters of the potential transaction retrieved from the memory;
receive one or more incentive quotes or account statistics from two or more of the plurality of electronic payment processors each having a respective one of a plurality of user account information assigned to the user, in response to transmitting the one or more parameters of the potential transaction; and
provide the one or more incentive quotes from the at least one of the plurality of electronic payment processors to the user.

27. The device of claim 26, wherein the processor is further configured to:
receive a selection of one or more of the plurality of electronic payment processors by the user for processing the potential transaction; and
initiate a transaction by processing the payment through the one of the plurality of electronic payment processors selected by the user.

28. The device of claim 26, wherein the device is one of a mobile device, a personal computer, a personal digital assistant a point of sale terminal, a kiosk terminal, and a central server.

29. The device of claim 26, wherein the one or more parameters of the potential transaction includes one or more of an amount of a payment, a merchant identity, an identification of goods or services, and an identification of a type of goods and services.
